(19) United States
(12) Patent Application Publication
(10) Pub. No.: US 2017/0308168 A1
(43) Pub. Date: Oct. 26, 2017

(54) ELECTRONIC DEVICE AND METHOD FOR TACTILE SIMULATION AND INTERACTION

(71) Applicant: HON HAI PRECISION INDUSTRY CO., LTD., New Taipei (TW)

(72) Inventors: SHUN-CHUAN YANG, New Taipei (TW); JIAN-CHENG HUANG, New Taipei (TW); CHUN-PING WANG, New Taipei (TW); CHANG-HSUN TU, New Taipei (TW)

(21) Appl. No.: 15/486,252

(22) Filed: Apr. 12, 2017

(30) Foreign Application Priority Data
Apr. 20, 2016 (CN) 201610248642.2

(51) Int. Cl. G06F 3/01; G06F 3/041; G06F 3/0488

(52) U.S. Cl. CPC G06F 3/016; G06F 3/0488; G06F 3/0416; G06F 2203/04105

(57) ABSTRACT

A method to communicate the effects of physical touches made to a touch screen includes acquiring touch information from a touch screen of a first device which is touched and controlling a touch screen of a second device to simulate effects of the touch applied to first device. The method utilizes piezoelectric elements, pressure sensors, temperature sensors, and temperature adjusting devices installed in the touch screens of both devices. A tactile interaction device is also provided.

### CROSS-REFERENCE TO RELATED APPLICATIONS

This application claims priority to Chinese Patent Application No. 201610248642.2 filed on Apr. 20, 2016.

### FIELD

The subject matter herein generally relates to tactile interaction, and particularly to a device and method for tactile interaction between users.

### BACKGROUND

People can communicate with each other through a telephone call or a video call no matter how far away they are, but they cannot experience the physical presence of the other person.

### BRIEF DESCRIPTION OF THE DRAWINGS

Implementations of the present technology will now be described, by way of example only, with reference to the attached figures.

FIG. 1 is a block diagram illustrating a first exemplary embodiment of a tactile interaction device.

FIG. 2 is a block diagram illustrating a second exemplary embodiment of a tactile interaction device.

FIG. 3 is block diagram illustrating a tactile interaction system applied in the tactile interaction device of FIG. 1 and FIG. 2.

FIG. 4 is a flowchart illustrating an exemplary embodiment of a tactile interaction method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”, it specifically indicates open-ended inclusion or membership in a so-described combination, group, series, and the like.

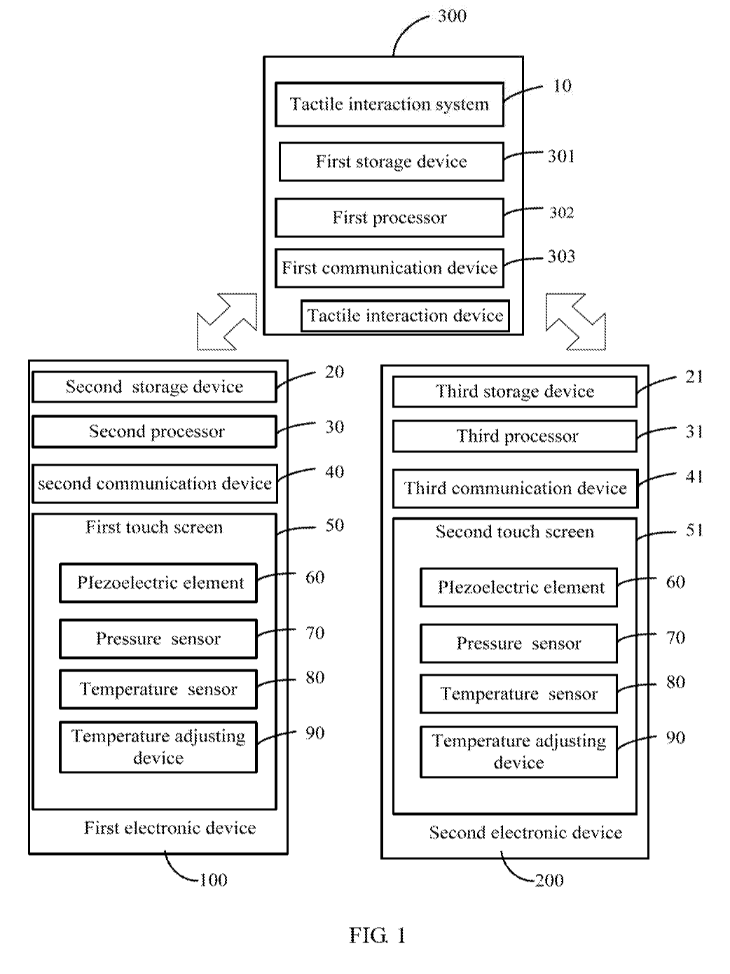

FIG. 1 illustrates a first exemplary embodiment of a tactile interaction device 300. The tactile interaction device 300 can communicate with a first electronic device 100 and a second electronic device 200. Both of the first electronic device 100 and the second electronic device 200 can include a touch input screen. When the touch input screen of the first electronic device 100 receives a touch input from a user, the tactile interaction device 300 acquires a touch information from the first electronic device 100, and controls the second electronic device 200 to simulate the effect of a touch on the touch input screen of the second electronic device 200.

In the first exemplary embodiment, the tactile interaction device 300 can include, but is not limited to, a first storage device 301, a first processor 302, and a first communication device 303. The first electronic device 100 can include, but is not limited to, a second storage device 20, a second processor 30, a second communication device 40, and a first touch screen 50. The second electronic device 200 can include, but is not limited to, a third storage device 21, a third processor 31, a third communication device 41, and a second touch screen 51. In the exemplary embodiment, the device 300 can be a server. The first electronic device 100 and the second electronic device 200 can be a smart phone or a tablet.

In the first exemplary embodiment, the first storage device 301, the second storage device 20, and the third storage device 21 respectively can be, but are not limited to, an internal storage system, such as a flash memory, a random access memory (RAM) for temporary storage of information, and/or a read-only memory (ROM) for permanent storage of information. Each of the storage devices 301, 20, and 21 also can be a storage system, such as a hard disk, a storage card, or a data storage medium.

In the first exemplary embodiment, each of the first processor 302, the second processor 30, and the third processor 31 can be, but are not limited to, a central processing unit, a digital signal processor, or a single chip, for example.

In the first exemplary embodiment, the first communication device 303, the second communication device 40, and the third communication device 41 respectively can be, but are not limited to, a BLUETOOTH module, a WI-FI module, or a ZIGBEE module.

In the first exemplary embodiment, the first touch screen 50 and the second touch screen 51 can be, but are not limited to, touch input screens, such as Liquid Crystal Display touch screen, or Organic Light-Emitting Diode touch screen.

In the first exemplary embodiment, each of the first touch screen 50 and the second touch screen 51 includes a number of piezoelectric elements 60, a number of pressure sensors 70, a number of temperature sensors 80, and a number of temperature adjusting devices 90. Each of the piezoelectric elements 60, the pressure sensors 70, the temperature sensors 80, and the temperature adjusting devices 90 has a location with coordinate values. Each piezoelectric element 60 is used to generate voltage signals under finger pressure, and deforms according to inputted voltage signals. Each pressure sensor 70 is configured to detect pressure values of a touch point when a touch operation is inputted to the first or second touch screens 50 or 51. Each temperature sensor 80 is used to detect temperature of a touch point when a touch operation is inputted to the first or second touch screen 50 or 51. The temperature adjusting device 90 is used to adjust the temperature of the first or second touch screen 50 or 51.

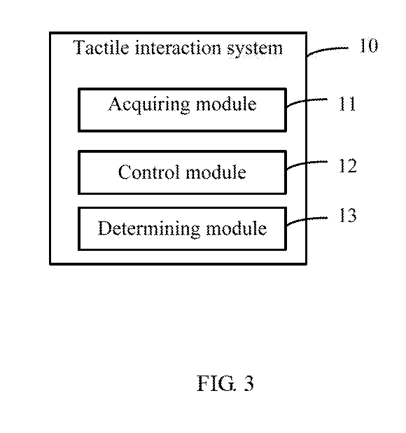

In the first exemplary embodiment, the first storage device 301 further can store a tactile interaction system 10. The interaction system 10 can include a number of modules, which are collection of software instructions stored in the first storage device 301 and executed by the first processor 302. Referring to FIG. 3, in at least one exemplary embodiment, the tactile interaction system 10 can include an acquiring module 11, a control module 12, and a determining module 13.

Referring to FIGS. 1 and 3, when the first touch screen 50 receives a touch input from a user, the acquiring module 11 acquires a touch information from the first touch screen 50. In at least one exemplary embodiment, the touch information can include, but is not limited to, one or more of deformation information, pressure information, and temperature information. The deformation information can include a location of each touched piezoelectric element 60 and voltage signals generated by the piezoelectric elements 60 of the first touch screen 50 when the first touch screen 50 is touched. The pressure information can include a location of each touched pressure sensor 70 and pressure values detected by the pressure sensors 70 of the first touch screen 50 when the first touch screen 50 is touched. The temperature information includes a location of each touched temperature sensor 80 and temperature values detected by the temperature sensors 80 of the first touch screen 50 when the first touch screen 50 is touched. In the first exemplary embodiment, the second communication device 40 transmits the touch information to the tactile interaction device 300 and the acquiring module 11 acquires the touch information transmitted from the first electronic device 100.

The control module 12 controls the second touch screen 51 to simulate the physical effects of the touch input according to the touch information acquired from the first electronic device 100.

In at least one exemplary embodiment, the control module 12 controls the second touch screen 51 to simulate the effects of multiple types of touches.

The control module 12 inputs voltage signals to corresponding piezoelectric elements 60 of the second touch screen 51 according to the acquired touch information. Each of the piezoelectric elements 60 in the second touch screen 51 has a location to correspond to the location of one of the touched piezoelectric elements 60 of the first touch screen that were touched. A value of each inputted voltage signal equals to an inverted value of the voltage signal generated by the piezoelectric element 60 of the first touch screen 50. Thus, the control module 12 controls the second touch screen 51 to deform contrary to the manner of deformation of the first touch screen 50 in a same location. For example, if the first touch screen 50 is pressed inwards, the control module 12 controls the second touch screen 50 to expand outwards in a corresponding location.

Referring to FIG. 1, the first storage device 301 further stores a mapping table, the mapping table records a relationship between a number of pressure values with respect to different colors. The determining module 13 acquires the pressure value on each touched pressure sensor 70 of the first touch screen 50 and the location of each touched pressure sensor 70 of the first touch screen 50, and determines a color according to the acquired pressure value and the mapping table. The control module 13 controls the second touch screen 51 in the corresponding location with respect to the first touch screen to display the color determined by the determining module 13. Thus, the pressure force applied to the first touch screen 50 can be indicated to the user of the second electronic device 200 by the color of the second touch screen 51.

The control module 13 further acquires the temperature values of the touched temperature sensors 80 of the first touch screen 50 and the location of the touched temperature sensors 80, and controls the temperature adjusting device 90 of the second touch screen 51 to adjust the temperature of the second touch screen 51 accordingly. Thus, the temperature of a part of the second touch screen 51 can be made equal to the temperature of the touch point of the first touch screen 50.

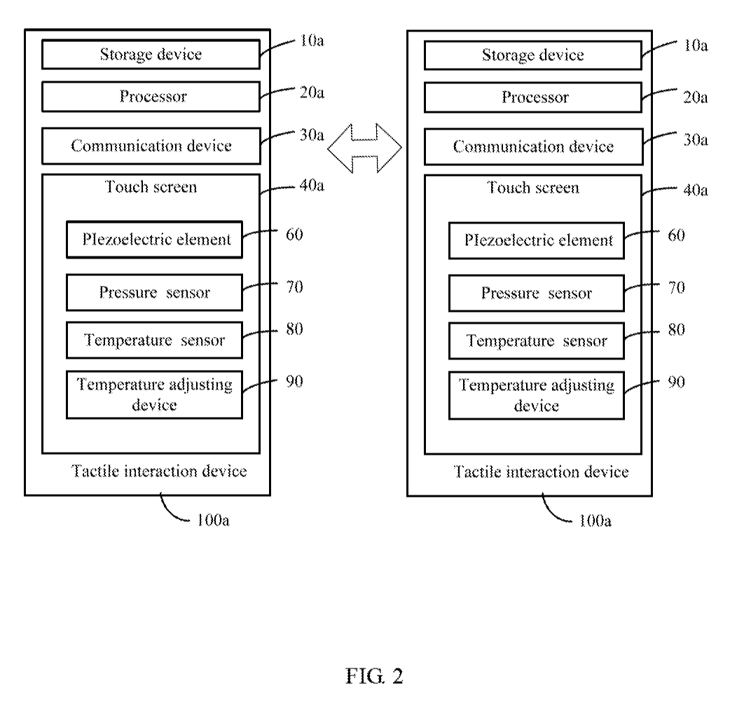

Referring to FIG. 2, in the second exemplary embodiment, each tactile interaction device 100a can include, but is not limited to, a storage device 10a, a processor 20a, a communication device 30a, and a touch screen 40a. The touch screen 40a of each tactile interaction device 100a can include, but is not limited to, a number of piezoelectric elements 60a, a number of pressure sensors 70a, a number of temperature sensors 80a, and a number of temperature adjusting devices 90a. In the second exemplary embodiment, a number of tactile interaction devices 100a can communicate with each other through the communication device 30a. The interaction system 10 in FIG. 3 can also be operated in each tactile interaction device 100a. The interaction system 10 can include a number of modules, which are collection of software instructions stored in the storage device 10a and executed by the processor 20a. The tactile interaction system 10 can include an acquiring module 11, a control module 12, and a determining module 13.

The tactile interaction device 10a can communicate with another tactile interaction device 10a if a touch operation is inputted, as the acquiring module 11 acquires the touch information from the touch screen 40a of the tactile interaction device 10a. The acquiring module 11 transmits the touch information to another tactile interaction device 10a by the communication device 30a.

The control module 12 is configured to controls the touch screen 40a of the tactile interaction device 10a to simulate a touch effect according to a acquired touch information received from another tactile interaction device 10a.

In the second exemplary embodiment, a tactile interaction process between the tactile interaction devices 10a is similar to the tactile interaction process in the first exemplary embodiment, thus specific details are not repeated.

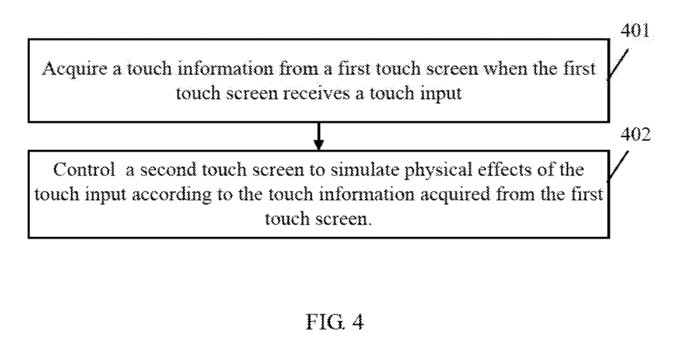

A method for tactile interaction is indicated in FIG. 4. The method is provided by way of example, as there are a variety of ways to carry out the method. Each block shown in FIG. 4 represents one or more processes, methods, or subroutines carried out in the example method. Additionally, the illustrated order of blocks is by example only and the order of the blocks can be changed. The example method can begin at block 401.

At block 401, an acquiring module acquires a touch information from a first touch screen when the first touch screen receives a touch input.

In the exemplary embodiment, the touch information can include, but is not limited to, one or more of deformation information, pressure information, and temperature information. The deformation information can include a location of each touched piezoelectric element and voltage signals generated by the piezoelectric elements of the first touch screen when the first touch screen is touched. The pressure information can include a location of each touched pressure sensor and pressure values detected by pressure sensors of the first touch screen when the first touch screen is touched. The temperature information can include a location of each touched temperature sensor of the first touch screen and temperature values detected by the temperature sensors of the first touch screen when the first touch screen is touched.

At block 402, a control module controls a second touch screen to simulate the physical effects of the touch input according to the touch information acquired from the first touch screen.

In at least one exemplary embodiment, the control module controls the second touch screen to simulate the effects of multiple types of touches.

The control module inputs voltage signals to the corresponding piezoelectric elements of the second touch screen according to the acquired touch information. Each of the piezoelectric elements in the second touch screen has a location to correspond to the location of one of the touched piezoelectric elements of the first touch screen that were touched. A value of each inputted voltage signal equals to an inverted value of the voltage signal generated by the piezoelectric element of the first touch screen.

A determining module acquires the pressure value on each touched pressure sensor of the first touch screen and the location of each touched pressure sensor of the first touch screen, and determines a color according to the acquired pressure value and a pre-stored mapping table. The pre-stored mapping table records a relationship between a number of pressure values with respect to different colors. The control module controls the second touch screen in the corresponding location with respect to the first touch screen to display the color determined by the determining module.

The control module further acquires the temperature values of the touched temperature sensors of the first touch screen and the location of the touched temperature sensors, and controls the temperature adjusting device of the second touch screen to adjust the temperature of the second touch screen accordingly.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A tactile interaction device comprising:
a communication device to communicate with at least a first electronic device and a second electronic device, the first electronic device comprising a first touch screen, the second electronic device comprising a second touch screen;
at least one processor; and
a storage device storing one or more programs, when executed by the at least one processor, the one or more programs cause the at least one processor to:
acquire a touch information from the first touch screen when the first touch screen receives a touch input; and
control the second touch screen to simulate physical effects of the touch input according to the touch information acquired from the first touch screen.

2. The tactile interaction device of claim 1, wherein each of the first touch screen and the second touch screen comprises a plurality of piezoelectric elements, the touch information comprises a deformation information, the deformation information comprises a location of each touched piezoelectric element and voltage signals generated by the piezoelectric elements of the first touch screen when the first touch screen is touched;
wherein the processor inputs voltage signals to the corresponding piezoelectric elements of the second touch screen according to the acquired touch information, each of the piezoelectric elements in the second touch screen has a location corresponding to a location of one of the touched piezoelectric elements of the first touch screen, a value of each inputted voltage signal equals to an inverted value of the voltage signal generated by the piezoelectric element of the first touch screen.

3. The tactile interaction device of claim 1, wherein each of the first touch screen and the second touch screen comprises a plurality of pressure sensors, the touch information comprises a pressure information, the pressure information comprises a location of each touched pressure sensor and pressure values detected by pressure sensors of the first touch screen when the first touch screen is touched;
wherein the processor determines a color according to the acquired pressure value and a pre-stored mapping table, the pre-stored mapping table records a relationship between a number of pressure values with respect to different colors, the processor further controls the second touch screen to display the color determined by the processor in a corresponding location with respect to the first touch screen.

4. The tactile interaction device of claim 1, wherein each of the first touch screen and the second touch screen comprises a plurality of temperature sensors, the touch information comprises a temperature information, the temperature information comprises a location of each touched temperature sensor of the first touch screen and temperature values detected by the temperature sensors of the first touch screen when the first touch screen is touched;
wherein the processor controls a temperature adjusting device of the second touch screen to adjust the temperature of the second touch screen according to the acquired temperature values and the acquired location of the first touch screen.

5. A tactile interaction device comprising:
a first touch screen;
a communication device to communicate with a electronic device, the electronic device comprises a second touch screen;
at least one processor; and
a storage device storing one or more programs, when executed by the at least one processor, the one or more programs cause the at least one processor to:
acquire a touch information from the second touch screen when the second touch screen receives a touch input; and
control the first touch screen to simulate physical effects of the touch input according to the touch information acquired from the second touch screen.

6. The tactile interaction device of claim 5, wherein each of the first touch screen and the second touch screen comprises a plurality of piezoelectric elements, the touch information comprises a deformation information, the deformation information comprises a location of each touched piezoelectric element and voltage signals generated by the piezoelectric elements of the second touch screen when the second touch screen is touched;
the processor inputs voltage signals to the corresponding piezoelectric elements of the first touch screen according to the touch information acquired from the second touch screen, each of the piezoelectric elements in the first touch screen have a location corresponding to a location of one of the touched piezoelectric elements of the second touch screen, a value of each inputted voltage signal equals to an inverted value of the voltage signal generated by the piezoelectric element of the second touch screen.

7. The tactile interaction device of claim 5, wherein each of the first touch screen and the second touch screen comprises a plurality of pressure sensors, the touch information comprises a pressure information, the pressure information comprises a location of each touched pressure sensor and pressure values detected by pressure sensors of the second touch screen when the second touch screen is touched;
wherein the processor determines a color according to the pressure value acquired from the second touch screen and a pre-stored mapping table, the pre-stored mapping table records a relationship between a number of pressure values with respect to different color, the processor further controls the first touch screen in a corresponding location with respect to the second touch screen to display the color determined by the processor.

8. The tactile interaction device of claim 5, wherein each of the first touch screen and the second touch screen comprises a plurality of temperature sensors, the touch information comprises a temperature information, the temperature information comprises a location of each touched temperature sensor of the second touch screen and temperature values detected by the temperature sensors of the second touch screen when the second touch screen is touched;
wherein the processor controls a temperature adjusting device of the first touch screen to adjust the temperature of the first touch screen according to the acquired temperature values and the acquired location of the second touch screen.

9. A tactile interaction method comprising:
acquiring touch information from a first touch screen when the first touch screen receives a touch input; and
controlling a second touch screen to simulate physical effects of the touch input according to the touch information acquired from the first touch screen.

10. The tactile interaction method of claim 9, wherein each of the first touch screen and the second touch screen comprises a plurality of piezoelectric elements, the touch information comprises a deformation information, the deformation information comprises a location of each touched piezoelectric element and voltage signals generated by the piezoelectric elements of the first touch screen when the first touch screen is touched;
wherein the method further comprises: inputting voltage signals to corresponding piezoelectric elements of the second touch screen according to the touch information acquired from the first touch screen, each of the corresponding piezoelectric elements in the second touch screen has a location to corresponding to a location of one of the touched piezoelectric elements of the first touch screen, a value of each inputted voltage signal equals to an inverted value of the voltage signal generated by the piezoelectric element of the first touch screen.

11. The tactile interaction method of claim 9, wherein each of the first touch screen and the second touch screen comprises a plurality of pressure sensors, the touch information comprises a pressure information, the pressure information comprises a location of each touched pressure sensor and pressure values detected by pressure sensors of the first touch screen when the first touch screen is touched;
wherein the method further comprises: determining a color according to the acquired pressure value and a pre-stored mapping table, the pre-stored mapping table records a relationship between a number of pressure values with respect to different colors; controlling the second touch screen to display the determined color in a corresponding location with respect to the first touch screen.

12. The tactile interaction method of claim 9, wherein each of the first touch screen and the second touch screen comprises a plurality of temperature sensors, the touch information comprises a temperature information, the temperature information comprises a location of each touched temperature sensor of the first touch screen and temperature values detected by the temperature sensors of the first touch screen when the first touch screen is touched;
wherein the method further comprises: controlling a temperature adjusting device of the second touch screen to adjust the temperature of the second touch screen according to the acquired temperature values and the acquired location of the first touch screen.
